(19) United States
(12) Patent Application Publication
(10) Pub. No.: US 2013/0149932 A1
(43) Pub. Date: Jun. 13, 2013

(54) COLORED FLAME RETARDANT SHAPED CELLULOSIC ARTICLE AND PRODUCTS PRODUCED FROM IT

(71) Applicants: Albert Leitner, Altmunster (AT); Gert Kroner, Lenzing (AT); Tom Burrow, Chellaston (GB); Gabriele Emlinger, Timelkam (AT); Ulf Mathes, Schwanenstadt (AT); Peter Wessely, Voclabruck (AT)

(72) Inventors: Albert Leitner, Altmunster (AT); Gert Kroner, Lenzing (AT); Tom Burrow, Chellaston (GB); Gabriele Emlinger, Timelkam (AT); Ulf Mathes, Schwanenstadt (AT); Peter Wessely, Voclabruck (AT)

(73) Assignee: Lenzing Aktiengesellschaft, Lenzing (AT)

(21) Appl. No.: 13/695,706

(22) PCT Filed: Apr. 20, 2011
(86) PCT No.: PCT/AT2011/000191

§ 371 Date: Mar. 1, 2013

(30) Foreign Application Priority Data
May 6, 2010 (AT) A 769/2010

(51) Int. Cl. C08L 1/00; D01F 2/00

(52) U.S. Cl. CPC C08L 1/00; D01F 2/00
USPC 442/301; 442/304; 442/414; 106/18.31

(57) ABSTRACT

The objective of this invention is to enable the production of colored shaped flame retardant cellulosic articles such as fibers and to use them to produce fabrics and similar items simply and at lower cost than if they were colored by dyeing after production. A product has been invented that is a fiber which is colored using an included pigment during its manufacture.

### FIELD OF THE INVENTION

The objective of this invention is to enable the production of colored shaped flame retardant (“FR”) cellulosic articles such as fibers and to use them to produce fabrics and similar items simply and at lower cost than if they were colored by dyeing after production. A product has been invented that is a fiber which is colored using an included pigment during its manufacture.

### BACKGROUND OF THE INVENTION

Current FR cellulosic fibers in the market can be used to produce colored fabrics, but require expensive dyeing of either the fiber or the fabric using reactive or vat dyes. When a currently available FR cellulosic fiber is blended with another fiber, it may be necessary to dye each fiber separately in the fabric adding to the expense and complexity of the production process. If a currently available FR cellulosic fiber is blended with a producer colored synthetic fiber, it would usually still be necessary to dye the fabric in order to color the FR cellulosic component.

The invention makes possible the production of colored fabric without using any dyeing process by blending the colored FR cellulosic fiber with a colored synthetic fiber. It also makes possible the production of colored fabric consisting entirely of the FR cellulosic fiber without using a dyeing process.

### PRIOR ART

Textile materials vary considerably in their ability to resist flame and hence protect underlying materials. Most fabrics made from natural fibers and from synthetic fibers will burn when exposed to flame. The rate of burn and ease of ignition are determined primarily by the chemical nature of the polymer from which the fiber is made and the construction of the fabric. Many polymers, such as cellulose, polyester and nylon will burn readily. The rate of burn is lower the heavier a fabric is. Wool is the most common fiber which has flame retardant properties to some degree—heavy weight wool fabrics will not burn readily and are used in firefighter's clothing.

Fabrics can be treated to make them flame retardant by applying an appropriate chemical to the fabric. The first FR treated fabrics used inorganic salts such as aluminum hydroxide, antimony trioxide and borates to make cotton fabrics flame retardant. These were effective but were non-durable to washing.

Organic phosphorous containing compounds that are reacted onto the cotton either by grafting or network formation are more durable and are widely used. Two of the leading brand names are Proban® and Pyrovatex®. While these finishes are durable, they can be removed by harsh chemical treatments and the level of finish reduces with the number of washing cycles. The finish application has an adverse stiffening effect on the fabric. Fabrics of this type are in use for protection from flame.

The first flame retardant man made fibers produced were made by the viscose process. A high viscosity liquid flame retardant additive was dispersed in the spinning solution prior to extrusion of the fiber. The liquid was trapped in the cellulose by physical means as very small bubbles. The result was effective as a flame retardant fiber, but the additive could be removed by repeated washing. The strength of the fiber is reduced in proportion to the amount of additive included. The additive was withdrawn from the market due to safety concerns and production of the fiber was discontinued.

An improved flame retardant viscose fiber can be produced by using a solid pigment flame retardant. The pigment is finely ground and mixed with the spinning solution prior to extrusion of the fiber. The result is a dispersion of the insoluble particulate additive in the fiber. The strength of the fiber is reduced in proportion to the amount of additive included. All of the cellulose in the fiber contains some of the additive and the additive cannot be removed by washing or normal fabric dyeing or finishing processes. Hence the result of the process is an inherently flame retardant fiber.

A further improvement can be achieved by incorporating the solid pigment flame retardant in the spinning solution used to produce modal fiber. The modal process is a modified viscose process designed to produce a fiber with a higher strength and higher wet modulus than normal viscose. The resultant fiber containing the flame retardant pigment is inherently flame retardant. It is stronger than fiber produced by the viscose process and gives fabrics with higher strength and better stability. Such a fiber is sold under the brand name “Lenzing FR®”

All currently available FR cellulosic fibers are supplied to the market as undyed (ecru) fiber. Most applications for the fiber require that fabrics produced from them are colored. For example, uniforms for riot police are often colored black; industrial workwear is usually colored and may be in dark shades; upholstery fabrics are usually colored. In order to produce colored fabrics using currently available FR cellulosic fibers, it is necessary to dye the fiber, yarn or fabric or print the fabric which can add considerably to the cost of producing the fabric.

The use of pigments to color shaped polymeric articles is well known. Many suitable pigments are available commercially. The use of pigments is often preferred to the use of dyestuffs as pigments are lower cost, do not require a reaction to occur to be incorporated into the article and are more stable to other processes which the article may be subjected to. An example of a pigment that is widely used is carbon black. Many other pigments could also be used alone or in combination.

### SUMMARY OF THE INVENTION

The invention relates in particular to flame-retardant regenerated celluloses which contain a coloring pigment and at least one flame retardant compound (in the following also simply referred to as “flame retardant”). Very suitable for the purpose of the present invention are flame retardant compounds of formula I

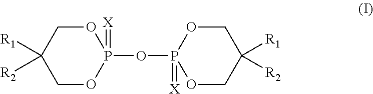

in which both Xs are sulphur and both R1 and both R2 simultaneously methyl, ethyl or propyl.

In formula I, R1 and R2 mean preferably a methyl residue.

The compounds of formula I are well-known and can be manufactured in a manner known to the expert e.g. in accordance with the method described in U.S. Pat. No. 4,22,0472.

Compounds of formula I can be incorporated into a regenerated cellulose fiber by mixing a sufficient quantity of a dispersion of the compound with the fiber spinning solution prior to extruding the solution to form the fiber which due to the inclusion of the compound of formula I is flame retardant. This process is described in detail in US2009247676.

One well-known and suitable compound belonging to the group of substances with the formula I is 2,2′-oxybis[5,5-dimethyl-1,3,2-dioxaphosphorinan]2,2′disulfide, which is commercially available.

Another suitable flame retardant compound is shown in formula II

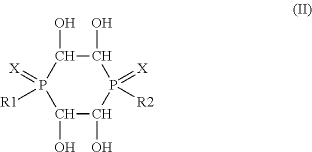

in which R1, R2 mean independently of each other an unsubstituted or substituted C1-12 alkyl-, C5-7 cycloalkyl-, C7-12 aralkyl- or C6-12 aryl-residue and X means oxygen or sulphur.

In formula II, R1 and R2 mean preferably an iso-butyl residue and X is preferably oxygen.

The compounds of formula II are well-known and can be manufactured in a manner known to the expert e.g. in accordance with the method described in U.S. Pat. No. 4,855,507.

Compounds of formula II can be incorporated into a regenerated cellulose fiber by mixing a sufficient quantity of a dispersion of the compound with the fiber spinning solution prior to extruding the solution to form the fiber which due to the inclusion of the compound of formula I is flame retardant. This process is described in detail in U.S. Pat. No. 6,130,327.

Surprisingly, it has now been found that it is possible to also incorporate a coloring pigment into the spinning solution at the same time as the flame retardant compound. For the purposes of the invention described here a coloring pigment is one which shows a color visible to the human eye. The pigment is locked within the structure of the cellulose as it is precipitated to form the fiber. The fiber so produced is permanently colored by inclusion of the pigment as well as being flame retardant. Even though the loading of “inert” (non-structural material) material in the fiber goes up to about 30% the deterioration in fiber properties (especially fiber strength) which would be expected by an expert can not be found. Therefore the effect of the coloring pigment on the fiber properties is minimal and the fiber can be processed later on in the textile chain in a conventional way without significant damage.

The pigment has no adverse effect on the flame retardancy of the fiber. Fiber which contains a coloring pigment has substantially the same flame retardancy as fiber which only contains the flame retardant compound.

### DETAILED DESCRIPTION OF THE INVENTION

Regenerated cellulose is manufactured by bringing the cellulose into solution form using established processes. This is done by dissolving the cellulose in a suitable organic solvent such as amine oxides, particularly N-methyl morpholine oxide (“lyocell process”) or by converting the cellulose into soluble cellulose derivatives such as cellulose xanthate (“viscose process”) or soluble tetramine-copper-(II)-hydroxide complexes (“Glanzstoff process”).

The compound(s) of formula I or II are added directly to the cellulose solution or dispersed in a suitable medium and then added to the cellulose solution. The addition is performed using well-known processes either continuously or discontinuously e.g. in batches, followed by rigorous mixing in order to distribute the dispersion of the compound(s) evenly in the cellulose solution.

The coloring pigment is added to the cellulose solution in a similar manner to the flame retardant. Finely ground pigment may be added to the solution directly in either a batch process or a continuous process, or it may be first made into a dispersion which is then added to the cellulose solution. Addition of the pigment is followed by rigorous mixing in order to distribute the dispersion of pigment evenly in the cellulose solution. Addition of the pigment may be done before addition of the flame retardant, after the addition of the flame retardant, or at the same time. The two materials may be dispersed in the same medium or may be mixed as powders.

The regenerated cellulose is precipitated from the cellulose solution which also contains the flame retardant and the coloring pigment using an established process e.g. by extruding this solution through fine nozzles or slits to manufacture filaments or films. The important technical properties of the regenerated cellulose are only slightly influenced by the addition of a flame-retardant agent of formula I or II and the coloring pigment according to the invention.

A preferred method of producing the regenerated cellulose flame retardant, colored article is the viscose process. The cellulose solution is a solution of cellulose xanthate which is prepared by reaction of alpha cellulose wood pulp with carbon disulphide and dissolving the product in sodium hydroxide solution. This solution is extruded through the spinnerets of a conventional spinning device into a precipitation bath which contains sulphuric acid (H2SO4), anhydrous sodium sulphate (Na2SO4) and anhydrous zinc sulphate (ZnSO4) in the proportions normally used to produce a non-flame retardant fiber. The fiber is then thoroughly washed and dried.

Variants of the viscose process designed to produce high wet modulus fiber (the “modal process”) and polynosic fiber may also be used to produce colored, flame retardant cellulosic fiber. The modal process is a second preferred process for producing colored flame retardant cellulosic fiber. This process is for example described in the Austrian patent publication AT 287905.

A third preferred method of producing a colored, flame retardant, cellulosic fiber in accordance with the invention is the method by which fiber is precipitated from solutions of the cellulose in amine oxides, preferably N-Methylmorpholine oxide.

It is generally known, that cellulose can be very well dissolved in aqueous tertiary amine oxides, especially N-Methylmorpholineoxide (NMMO). The manufacture of cellulosic products from such solutions of cellulose in amine oxides is carried out in known manner by extruding the solution through a shaping tool and conducting the solution into an aqueous precipitation bath whilst stretching it, whereby the cellulose is precipitated from the solution.

It has been shown, that the compounds of formula (II) and especially the compound of formula (II), in which R1 and R2 mean iso-butyl and X means oxygen and commercially available pigments are very stable against the conditions of the preferred processes in comparison with commercial products known in the state of the art. Thereby a colored, flame retardant, cellulosic product can be obtained in an economic manner.

The flame retardant cellulose can be present in the form of e.g. a fiber or a film depending on the shaping procedure.

Regenerated flame-retardant celluloses in accordance with the invention contain the flame retardant pigment in quantities of 5-35 weight percentage and preferably 10-25 weight percentage related to 100 weight percentage of pure, regenerated cellulose. Corresponding amounts of the compound(s) are added to the cellulose solution before shaping.

Regenerated flame-retardant celluloses in accordance with the invention also contain a pigment in the quantity and of the type required to give the desired color. For example to produce a black fiber, 3 to 10% by weight based on pure regenerated cellulose of color 6903 could be used, preferably 5 to 8% and in particular 7% by weight. The greater the quantity of pigment used, the deeper the shade of color produced. The operator of the process should determine by trial the precise quantity and type required to produce the target color.

The manufacture of dispersions in accordance with the invention is performed in well-known manner e.g. by grinding a concentrated mixture comprising a dispersion agent, a dispersion medium and compound(s) of formula I e.g. in a ball, sand, glass bead or quartzite mill until the size of the undissolved particles lies in the average of 0.5-5 .mu.m, preferably 1 .mu.m and if necessary by the adjustment of the desired concentration as a result of adding a dispersion medium which is preferably water.

Many of the pigments used to color polymeric articles are supplied by their manufacturer in the required particle size for use in the invention.

In general the dispersions in accordance with the invention contain 10-60 weight percentage, preferably 15-50 weight percentage and in particular 20-40 weight percentage of a compound or a mixture of the compounds of formula I or/and II, 4-50 weight percentage, preferably 5-45 weight percentage and in particular 6-35 weight percentage of a dispersion agent, based on the weight of the flame retardant pigment. The remainder is dispersion medium, preferably water.

Dispersions of the coloring pigments are well known and are available from many companies.

The product of this invention can be a colored, flame retardant, cellulosic fiber. It can be used in all of the applications where flame retardant cellulosic fibers are currently used. These include but are not limited to:

Military clothing

Body armour

Industrial workwear including workwear designed to prevent injury from molten metal splashes and from electric arcs

Clothing for firefighters including all parts of the protective clothing

Clothing for use by civil authorities (eg riot police)

Fabrics for use in the automotive industry, the rail industry and the aircraft industry as a component in the construction of vehicles, aircraft and vessels

Upholstered furniture

Home furnishings

Apparel with enhanced safety performance (eg children's sleepwear)

The colored flame retardant cellulosic fiber can be used on its own or as a component in fabrics which give the following benefits:

High color fastness

The wear comfort associated with cellulosic fibers

Exceptional heat protection

Inherently flame retardant

Outstanding moisture management giving lower physiological stress in use

Lower or zero dyeing costs

High yarn regularity

Simpler processing

Significantly reduced environmental impact due to the elimination of the need for dyeing of the cellulose component.

Consistent coloration within a delivery and from delivery to delivery

The colored flame retardant cellulosic fiber may be used as the sole component of a fabric or may be mixed with other fibers to give fabrics with a combination of the properties of the components. Such other fibers may be flame-resistant or even not flame-resistant fibers. This can be achieved by mixing two or more fibers together to give yarns that are used to make a fabric. Alternatively it may be achieved by using a yarn made from colored flame retardant cellulosic fiber combined with yarns made from one or more other fibers as for example the warp and the weft in a woven fabric. Any other method of combining colored flame retardant cellulosic fiber with one or more other fiber components in a fabric are also part of the invention. Such fabric can be either a flame-resistant or even not flame-resistant.

A fabric consisting solely of colored flame retardant cellulosic fiber will give a fabric which is the color of the fiber used to produce it. No further dyeing treatment is required and the color will be permanent for the life of the fabric.

Alternatively, such a fabric consisting of colored flame retardant cellulosic fiber may be dyed to change the color. The effect of this dyeing will be to add the color produced by the dye to the color of the colored flame retardant cellulosic fiber.

Fabrics which consist of colored flame retardant cellulosic fiber and a further non-colored component fiber(s) will have a color which is a diluted shade of the color of the colored flame retardant cellulosic fiber. For example if black flame retardant cellulosic fiber is blended with white meta-aramid fiber, the resultant fabric will be grey—the shade of grey dependent on the percentage of the components.

The colored flame retardant cellulosic fiber may also be mixed in a fabric with other colored fibers. The effect of this would be to give a color which is contributed to by each of the components in proportion to the percentage of the component. For example, if a black flame retardant cellulosic fiber is blended with a bright red meta-aramid fiber the resultant fabric will be dark red. As a further example, if a red flame retardant cellulosic fiber is combined with a red meta-aramid fiber the resultant fabric will be red. As another further example, if a blue flame retardant cellulosic fiber is combined with a red meta-aramid fiber the resultant fabric will be purple. Such combinations of fibers make possible the production of fabrics with a wide range of colors. This eliminates the need for dyeing of fabrics which reduces costs, shortens processing time and greatly reduces the environmental effects of producing colored fabrics.

Fabrics produced from colored flame retardant cellulosic fiber have a tendency to fibrillate when laundered as part of their normal use. That is when a fabric of which the fiber is a component is subject to wet abrasion, the fiber is caused to split into very small fibrils which are attached to the surface of the fiber. The effect of this fibrillation is to make the fabric look frosted which is undesirable as any change in appearance of a fabric can be. This frosting may be variable over the surface of the fabric giving undesirable white lines or patterns on the surface. This is particularly the case when the lyocell process or the modal process is used as the basis for making the colored flame retardant cellulosic fiber.

The fibrillation of the surface of fabric produced from colored flame retardant cellulosic fiber can be completely eliminated by the application of a crease resist resin finish, for example the Fixapret range of finishes from BASF SE or similar products sold by suppliers of textile finishes. Such finishes are routinely used in the industry for cellulosic fabrics as a means of improving fabric stability and appearance after washing. A resin finish can be applied to the fabric as part of the same process that would be used to apply water repellents, soil release agents and oil repellents. Thus the additional cost is mainly the cost of the finishing chemical. A 100% black flame retardant cellulosic fiber did not fibrillate when a resin finish was applied. For articles that will not be laundered, there is no need for resin finishing—for example body armour components.

In addition to the colored flame retardant cellulosic fiber in staple fiber form as described above, the shaped, colored flame retardant cellulosic article of the invention may take the form of any shaped article which can be produced from cellulose solutions. It may be in the form of a film, continuous filament yarn, a tow, short cut fiber or powder produced from fiber or any other shaped article produced from a cellulose solution. Such products could be produced using existing processes by adding a pigment and a flame retardant to the cellulose solution prior to forming the shaped article.

The invention will now be illustrated by examples. These examples are not limiting the scope of the invention in any way.

### EXAMPLES

### Example 1

A colored FR fiber was produced by adding to a previously prepared viscose solution suitable for producing modal fiber: 1) a dispersion of FR additive 2,2′-oxybis[5,5-dimethyl-1,3,2-dioxaphosphorinan]2,2′disulfide of a concentration and quantity calculated to give 25% on the weight of cellulose in the fiber and 2) a dispersion of commercially available carbon black of a concentration and quantity calculated to give 7% carbon black on the weight of cellulose in the fiber. The dispersions were mixed well with the viscose solution. The resulting viscose plus additives was extruded through a spinneret into a spin bath of the composition required to give modal fiber. The resulting rope of fibers was stretched as normal for producing modal fiber. It was then cut into staple fiber lengths and was washed. A finish was applied to the fiber and it was dried. The resulting fiber was a black 2.2 dtex staple fiber suitable for processing into yarn and fabric.

### Example 2

The fiber of example 1 was tested for its physical properties and compared to the physical properties of an FR fiber also produced according to the Modal process without the addition of a coloring pigment but with the same amount of the same FR additive. The results were as shown in Table 1. Obviously the additional pigment does not significantly damage the fiber properties. Instead even a slight increase in fiber tenacity occurred.

TABLE 1

| | Black FR fiber | White FR fiber |
|---|---|---|
| Titer (dtex) | 2.24 | 2.16 |
| Dry tenacity (cN/Tex) | 26.5 | 23.7 |
| Wet tenacity (cN/Tex) | 14.1 | 13.5 |
| Dry elongation at break (%) | 16.7 | 13.3 |
| Wet elongation at break (%) | 16.7 | 13.5 |

### Example 3

The fiber of example 1 was spun into a yarn of yarn count 50 Nm via a ring spinning system. The properties of the yarn were compared to similar yarns produced from white (i. e. uncolored) FR fiber produced by the modal process and with yarn spun from a standard modal fiber without any FR additive. The results of yarn tests are given in Table 2. This shows that also in the yarn there is no negative influence of the added color pigment on the mechanical properties.

TABLE 2

| | | | Standard |
|---|---|---|---|
| | Black FR | White FR | Modal |
| Yarn Count | 50 | 50 | 50 |
| Dry yarn tenacity | 14.9 | 12.9 | 18.6 |
| (cN/Tex) | | | |
| Elongation at break (%) | 11 | 8 | 9 |

### Example 4

The black fiber of example 1 was blended 50/50 by weight with a black 2.2 dtex meta-aramid staple fiber which had been produced by the addition of carbon black to the dope prior to spinning. The resultant yarn had a yarn count of 30 Nm. The yarn was woven into a plain weave fabric by a normal weaving process. The fabric was prepared and then finished with Fixapret CP. The resultant fabric was black and had a good stability in washing, good pilling performance and good creasing performance. No dyeing process was required which means a significant reduction of the processing cost of the fabric. Nevertheless the fabric was flame resistant and had minimal shrinkage on exposure to flame.

What we claim is:

1. A shaped cellulose article which has been coloured and made flame retardant by the addition to a cellulose solution during manufacture of both a pigment to give the target colour and a flame retardant compound to make it flame retardant.

2. A shaped cellulose article according to claim 1 wherein the flame retardant compound is 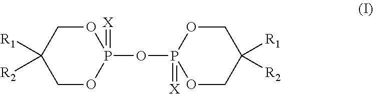
in which both Xs are sulphur and both R₁ and both R₂ simultaneously methyl, ethyl or propyl or 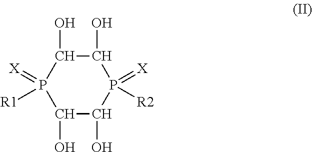
in which R₁, R₂ mean independently of each other an unsubstituted or substituted C1-12 alkyl-, C5-7 cycloalkyl-, C7-12 aralkyl- or C6-12 aryl-residue and X means oxygen or sulphur.

3. A shaped cellulose article according to claim 1 wherein the article is a fibre or a filament.

4. A method for producing the cellulosic article of claim 1, wherein the target colour and the flame retardant compound are added to a cellulose solution during manufacture.

5. The method according to claim 4 wherein the target colour and the flame retardant compound are added using at least one non-ionic or anionic dispersing agent.

6. Use of a shaped cellulose article according to claim 1 wherein the cellulosic article is blended with an article of a different colour to obtain a coloured, flame retardant second article.

7. Use of a shaped cellulose article according to claim 3 wherein the cellulosic article is blended with flame-resistant or not flame-resistant fibres.

8. Use of a shaped cellulose article according to claim 3 for the manufacture of yarns.

9. Use of a shaped cellulose article according to claim 3 for the manufacture of a woven fabric.

10. Use of a shaped cellulose article according to claim 3 for the manufacture of a knitted fabric.

11. Use of a shaped cellulose article according to claim 3 for the manufacture of a nonwoven fabric
